(19) United States
(12) Patent Application Publication
(10) Pub. No.: US 2004/0188964 A1
(43) Pub. Date: Sep. 30, 2004

(54) Double layer staggered roller installed hand truck for easy loading and unloading

(76) Inventors: Junwon Choi, Irvine, CA (US); Yongchae Chee, Los Angeles, CA (US)

Correspondence Address: Eugene Oak, Ph.D.,J.D., Patent Attorney, 610 S. Van Ness Ave., Los Angeles, CA, 90005, US

(21) Appl. No.: 10/395,732

(22) Filed: Mar. 25, 2003

(51) Int. Cl. B62B 3/00

(52) U.S. Cl. 280/47.27

(57) ABSTRACT

A novel two wheel-hand truck for easy, semi-automatic, loading and unloading, is equipped with a means, which is installed in the platform of the hand-truck, including but not limited to, double layers, upper and lower layer, of staggered rollers in the platform, a synthetic rubber belt optionally surrounding the upper layer rollers to fill the clearances, and two wheels. The rollers are constructed of cast iron having outer diameter of 3 to 30 mm. Diameter of all the rollers of the upper layer and the lower layer may be the same. More than one row of the double layers may be installed in row in a platform. The front edge of the platform is tapered for easy access of the bottom of the luggage to be loaded.

This invention relates to a semi-automatic two-wheel hand truck enabling easy loadings and unloading of a luggage.

### FIELD OF THE INVENTION

A novel two-wheel hand truck has double layers, staggered rollers in the platform for easy loading and unloading of luggage.

### DESCRIPTION OF THE PRIOR ARTS

U.S. Pat. No. 2,578,887 to Jackson et. al, U.S. Pat. No. 2,766,543 to Beck, U.S. Pat. No. 2,360,799 to Slingsby, and U.S. Pat. No. 1,710,893 to Phillips illustrate a two wheel hand trucks, which have various shape of pushing means for unloading luggage on the cart. The user operates the pushing means by hands. U.S. Pat. No. 2,838,193 to Statton, U.S. Pat. No. 2,476,202 to Lozon, Sr., and U.S. Pat. No. 528,443 to Randall illustrate hand trucks, which have luggage pushing means operated by a user's foot. Purpose of those pushing means is to accomplish an easy unloading.

None of prior art utilizes rollers for dolly or hand trucks.

U.S. Pat. No. 6,471,045 to Harden illustrates a roller and belt conveyor system with several roller assemblies supporting a plurality of conveyor belt sections for conveying articles. U.S. Pat. No. 5,152,522 to Yamashita illustrates a roller assembly, on one of a pair of shafts are axially arranged in staggered positions with those on the other shaft.

U.S. Pat. No. 4,546,631 to Eisinger, U.S. Pat. No. 4,287,743 to Hantschk, U.S. Pat. No. 2,769,478 to Schane, U.S. Pat. No. 2,749,962 to Kitselma, illustrate roller mechanism and method for forming helical structures from a feed wire or rod. Pluralities of rollers are staggered.

U.S. Pat. No. 4,214,379 to Hope, et al. illustrates a gear driven transport rollers arranged in a staggered pattern. It carries the film through the rack along a sinuous path. All of the prior art rollers illustrate staggered roller for transporting a thin material between the rollers.

None of the prior art illustrates a simple, easy and novel method of loading/unloading and transporting mechanism of this invention utilizing an assembly of staggered rollers.

### SUMMARY OF THE INVENTION

It is the purpose of this invention to provide a novel easy, safe and semi-automatic loading/unloading hand truck. A novel two wheel-hand truck for that purpose is equipped with a means, which is installed in the platform of the hand-truck, including but not limited to, double layers, upper and lower layers, of staggered rollers in the platform, a synthetic rubber belt optionally surrounding the upper layer rollers, and two wheels. The rollers are constructed of cast iron having outer diameter of 3 to 30 mm. Surface of the rollers may be coated with synthetic rubber. Diameter of all the rollers of upper layer and lower layer may be the same. More than one row of the double layers may be installed in a row in a platform. The front edge of the platform is tapered for easy access of the bottom of the luggage to be loaded.

### BRIEF DESCRIPTION OF THE DRAWINGS

FIG. 1 is a perspective view of the two-wheel hand truck of this invention.

FIG. 2 is a cross sectional side view of the staggered rollers in the platform of the hand truck of this invention along the line ‘A-A’ in the FIG. 1.

FIG. 2-1 is a cross sectional side view of the staggered rollers in the platform of the hand truck of this invention along the line ‘A-A’ in the FIG. 1 when a synthetic rubber belt is optionally engaged.

FIG. 3 is a schematic drawing showing the relative movement of rollers, luggage, and hand truck of this invention when loading a luggage.

FIG. 4 is a schematic drawing showing how to use the hand truck to move to another place with luggage.

FIG. 5 is a schematic drawing showing the relative movement of rollers, luggage, and hand truck of this invention when unloading a luggage.

FIG. 6. is an exploded schematic drawing showing the connection of the rollers to the dust cover equipped bearings in the side wall of the platform of the hand truck of this invention.

FIG. 7. is a partial perspective view of a conventional dust cover equipped bearings installed to the hand truck of this invention.

FIG. 8 is a side view of a roller showing the triangular shaft for engaging to the bearing.

### DETAILED DESCRIPTION OF THE PREFERRED EMBODIMENTS

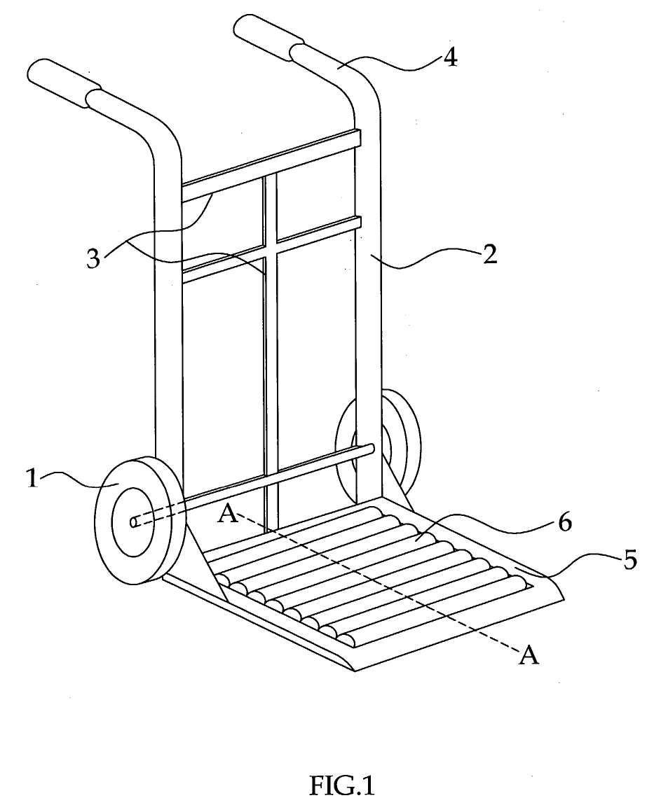

FIG. 1 is a perspective view of the two-wheel hand truck of this invention. The hand truck has two wheels (1), rail arms (2), crossing bars (3), handles (4) and toe platform (5), and plurality of rollers (6).

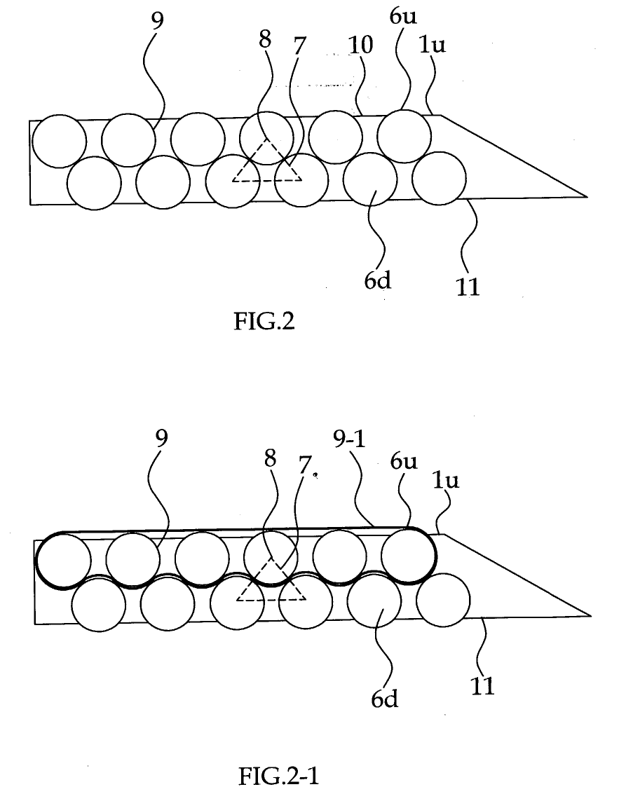

FIG. 2 is a cross sectional side view of the staggered rollers in the platform of the hand truck of this invention along the line ‘A-A’ in the FIG. 1. The upper layer rollers (6u) and lower layer rollers (6d) are staggered with respect to each other in a way of consisting a triangle (7) by the three centers (8) of neighboring three rollers. The outer face (9) of each roller contacts directly to the neighboring roller's outer surface (9) of the opposite layer. Rollers on the same layer do not contact each other. The upper surface of the upper layer's roller (6u) emerges above the upper surface (10) of the platform and the lower surface of the lower surface of the lower layer's roller (6d) emerges below the lower surface (11) of the platform. The outer surface (9) of the upper layer's rollers may be coated with a synthetic rubber. A synthetic rubber belt (9-1) is engaged optionally surrounding the upper layer's rollers (6u) as shown in FIG. 2-1.

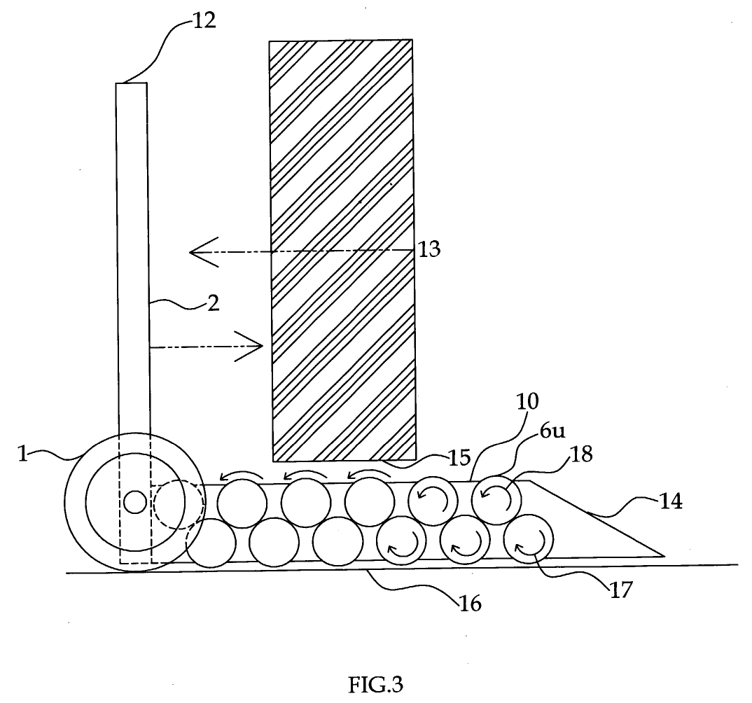

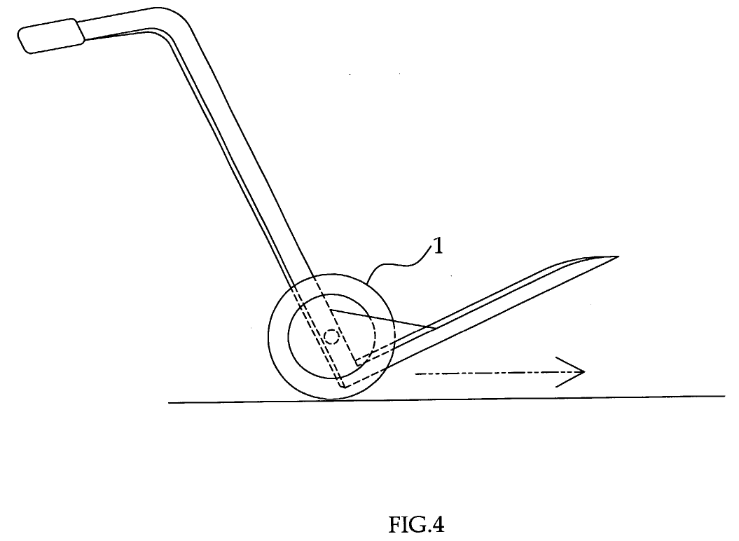

FIG. 3 is a schematic drawing showing the relative movement of rollers (6), luggage (13), and hand truck (12) of this invention when loading a luggage. When loading a luggage (13), a user put the hand truck (12) of this invention in front of the luggage (13) and pushes the hand truck (12) forward to the direction of the luggage (13). The tapered nose (14) of the platform, firstly, inroad into the under side of the luggage (13). For further pushing of the luggage, the bottom of the luggage (15) is mounted on the platform (5) and contacts the upper surfaces of the upper layer's rollers (6u), which are exposed above the upper surface (10) of the platform (5). As shown in FIG. 3, when a user pushes the hand truck forward, the lower layer's rollers (6d), contacting the ground (16), turns clockwise (17). It is clear that at the opposite side the lower layer rollers look (6d) turning counter-clockwise. At the same time, the upper layer's rollers (6u) turns counter-clockwise (18), induced by the rotation of the lower layer's rollers (6d). The upper layer's rollers movement drags the bottom of the luggage (15) into the direction of the rail arm (2). Pushing of the hand truck (12) more forward moves the luggage (13) from the front tip (14) of the platform to the inner side of the hand truck. For moving from one place to another place, the hand truck should be leaned backward as shown in FIG. 4.

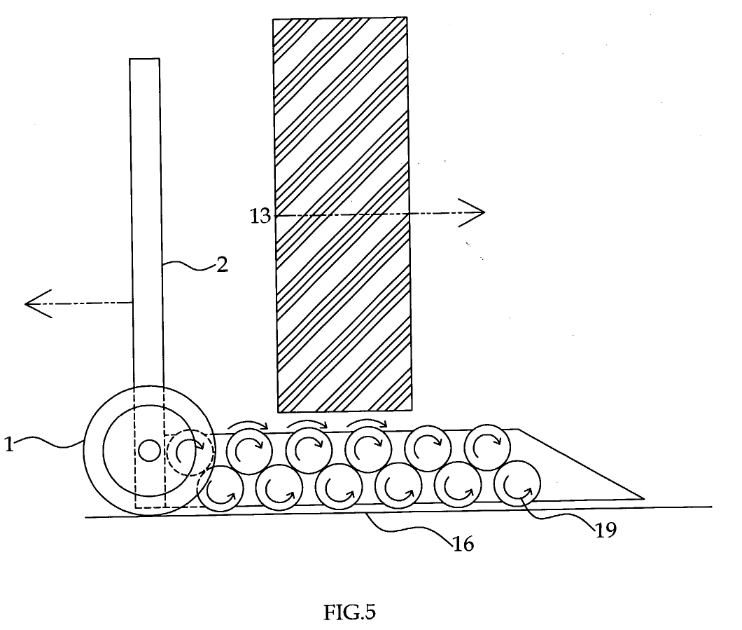

Likewise, an unloading the luggage (13) is much easier. FIG. 5 is a schematic drawing showing the relative movement of rollers, luggage, and hand truck of this invention when unloading a luggage. Putting the hand truck (12) in an up-right position and pulling the truck backward is illustrated in FIG. 5. The lower layer's rollers (6d) turn counter-clockwise (19) and this time turns the upper layer's rollers (6u) clockwise (20). The upper layer's rollers (6u) drags the luggage (13) to the front side of the hand truck (12) and finally unloads it.

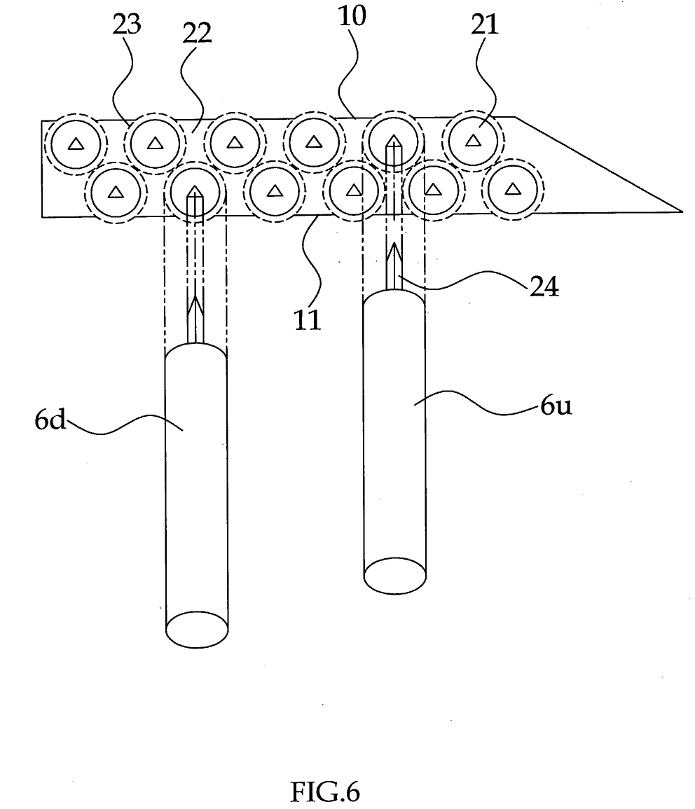

FIG. 6. is an exploded schematic drawing showing the connection of the rollers (6u and 6d) to the dust cover equipped bearings (21) in the side wall (22) of the platform of the hand truck of this invention. The bearings (21) are mounted in the side wall (22) of the platform. Their relative positions are decided by the relative position of the rollers. As indicated as (23) in FIG. 6 and shown in FIG. 2, the upper layer rollers (6u) and lower layer rollers (6d) are staggered with each other in a way of constituting a triangle (7) by the three centers (8) of neighboring three rollers. The upper surface of the upper layer's roller (6u) emerges above the upper surface (10) of the platform and the lower surface of the lower surface of the lower layer's roller (6d) emerges below the lower surface (11) of the platform. But the bearings (21) are installed within the limit of the boundary of the side wall (22) of the platform (5). The centers of the bearings (21) match the rotational centers of the rollers (6u and 6d). The rollers (6u and 6d) are engaged to the bearings (21) by the triangular shaft (24).

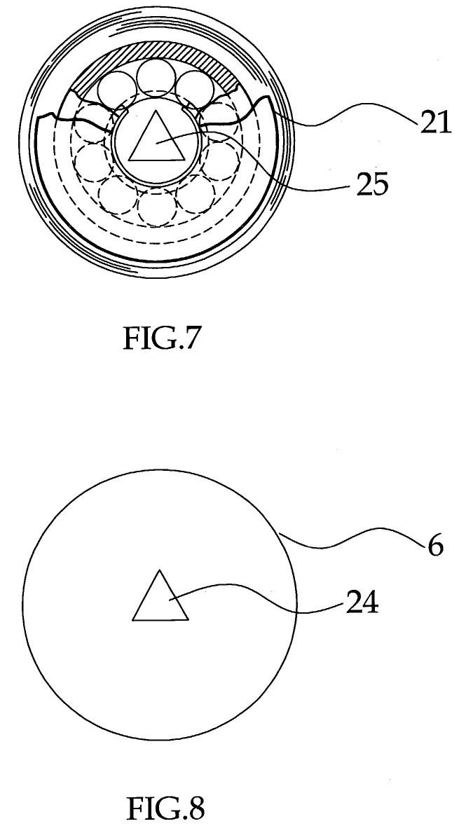

FIG. 7. is a partial perspective drawing of a conventional dust cover equipped bearing (21), with triangular window (25) for receiving a triangular shaft (24) of the rollers (6), installed to the hand truck of this invention. FIG. 8 is a side view of a roller showing the triangular shaft (24) for engaging into the bearings (21).

What is claimed is:

1. A semi-automatic loading/unloading two wheel-hand truck is comprised of two wheels, rail arms, crossing bars, handles, toe platform having tapered front nose and void in the middle, and plurality of double layer staggered rollers, the upper layer rollers and lower layer rollers consist a triangle with the three centers of neighboring three rollers contacting directly each other on the other layer meanwhile avoiding contact with other rollers on the same layer, which are made of cast iron rods having outer diameter of 3 to 30 mm and engaged to the platform by dust cover equipped bearings, in the platform.

2. The outer diameter of the rollers, in claim 1, is the same as the inner diameter.

3. The outer surface of the rollers of the upper layer, in claim 1, is coated with a synthetic rubber.

4. The upper layer's rollers, in claim 1, are surrounded with a synthetic rubber belt.
